(19) United States
(12) Patent Application Publication
(10) Pub. No.: US 2015/0341773 A1
(43) Pub. Date: Nov. 26, 2015

(54) METHODS AND APPARATUSES FOR EFFICIENT SIGNALING IN A SYSTEM SUPPORTING D2D OVER THE AIR DISCOVERY

(71) Applicant: NOKIA TECHNOLOGIES OY, Espoo (FI)

(72) Inventors: Cássio Ribeiro, Espoo (FI); Zexian Li, Espoo (FI); Juha Korhonen, Espoo (FI); Carl Wijting, Espoo (FI)

(21) Appl. No.: 14/442,499

(22) PCT Filed: Dec. 21, 2012
(86) PCT No.: PCT/US12/71353

§ 371 Date: May 13, 2015

(51) Int. Cl. H04W 8/00; H04L 12/807; H04W 24/10; H04W 48/16; H04W 4/00; H04W 76/02

(52) U.S. Cl. CPC H04W 8/005; H04W 4/008; H04W 76/023; H04W 24/10; H04W 48/16; H04L 47/27; H04W 84/22

(57) ABSTRACT

Methods, apparatuses, and computer program products for efficient signaling in a system supporting D2D over the air discovery are provided. One method may include receiving at a user equipment an indication of screening policies and related parameters for beacon signals received from other devices. The method may then include detecting the beacon signals and applying the screening policies and related parameters to determine which of the detected beacon signals should be included in a report. The method may also include leaving out from the report any of the detected beacon signals that do not meet the screening policies' requirements and/or criteria, and transmitting the report from the user equipment to a network node.

### BACKGROUND

1. Field

Embodiments of the invention generally relate to wireless communication systems, such as, but not limited to, the Universal Mobile Telecommunications System (UMTS) Terrestrial Radio Access Network (UTRAN), Long Term Evolution (LTE) Evolved UTRAN (E-UTRAN), and/or LTE-Advanced (LTE-A). Some embodiments relate to device-to-device (D2D) communication in communication systems, such as LTE.

2. Description of the Related Art

Universal Mobile Telecommunications System (UMTS) Terrestrial Radio Access Network (UTRAN) refers to a communications network including base stations, or Node Bs, and for example radio network controllers (RNC). UTRAN allows for connectivity between the user equipment (UE) and the core network. The RNC provides control functionalities for one or more Node Bs. The RNC and its corresponding Node Bs are called the Radio Network Subsystem (RNS). In case of E-UTRAN (enhanced UTRAN) no RNC exists and most of the RNC functionalities are contained in the eNodeB (evolved Node B, also called E-UTRAN Node B).

Long Term Evolution (LTE) or E-UTRAN refers to improvements of the UMTS through improved efficiency and services, lower costs, and use of new spectrum opportunities. In particular, LTE is a 3rd generation partnership project (3GPP) standard that provides for uplink peak rates of at least 50 megabits per second (Mbps) and downlink peak rates of at least 100 Mbps. LTE supports scalable carrier bandwidths from 20 MHz down to 1.4 MHz and supports both Frequency Division Duplexing (FDD) and Time Division Duplexing (TDD). Advantages of LTE are, for example, high throughput, low latency, FDD and TDD support in the same platform, an improved end-user experience, and a simple architecture resulting in low operating costs.

Further releases of 3GPP LTE (e.g., LTE Rel-11, LTE-Rel-12) are targeted towards future international mobile telecommunications advanced (IMT-A) systems, referred to herein for convenience simply as LTE-Advanced (LTE-A). LTE-A is directed toward extending and optimizing the 3GPP LTE radio access technologies. A goal of LTE-A is to provide significantly enhanced services by means of higher data rates and lower latency with reduced cost. LTE-A will be a more optimized radio system fulfilling the international telecommunication union-radio (ITU-R) requirements for IMT-Advanced while keeping the backward compatibility.

With the proliferation of devices equipped with a cellular modem, D2D (device-to-device) communication, which will allow new types of local services, has become a potentially useful optimization that may significantly enhance the capabilities of LTE as a universal connectivity technology. D2D communications is expected to become a new feature to be supported by LTE Rel-12 or 13.

### SUMMARY

One embodiment is directed to a method including receiving, by a user equipment, an indication of screening policies and related parameters for beacon signals received from other devices. The method further includes detecting the beacon signals, applying the screening policies and related parameters to determine which of the detected beacon signals are included in the report, and transmitting the report to a network node.

Another embodiment includes an apparatus. The apparatus includes at least one processor, and at least one memory including computer program code. The at least one memory and computer program code, with the at least one processor, cause the apparatus at least to receive an indication of screening policies and related parameters for beacon signals received from other devices, detect the beacon signals, apply the screening policies and related parameters to determine which of the detected beacon signals are included in a report, and transmit the report to a network node.

Another embodiment is directed to a computer program embodied on a computer readable medium. The computer program is configured to control a processor to perform a process. The process includes receiving an indication of screening policies and related parameters for beacon signals received from other devices. The process further includes detecting the beacon signals, applying the screening policies and related parameters to determine which of the detected beacon signals are included in a report, and transmitting the report to a network node.

Another embodiment is directed to an apparatus including means for receiving an indication of screening policies and related parameters for beacon signals received from other devices. The apparatus further includes means for detecting the beacon signals, means for applying the screening policies and related parameters to determine which of the detected beacon signals are included in a report, and means for transmitting the report to a network node.

Another embodiment is directed to a method including transmitting, from a network node, an indication of screening policies and related parameters to be applied by a user equipment when forming a report of beacon signals received from other devices. The method may further include receiving, at the network node, the report from the user equipment. The report may include beacon signals that meet the requirements of the screening policies and related parameters transmitted to the user equipment.

Another embodiment includes an apparatus. The apparatus includes at least one processor, and at least one memory including computer program code. The at least one memory and computer program code, with the at least one processor, cause the apparatus at least to transmit an indication of screening policies and related parameters to be applied by a user equipment when forming a report of beacon signals received from other devices, and to receive the report from the user equipment. The report may include beacon signals that meet the requirements of the screening policies and related parameters transmitted to the user equipment.

Another embodiment is directed to a computer program embodied on a computer readable medium. The computer program is configured to control a processor to perform a process. The process includes transmitting an indication of screening policies and related parameters to be applied by a user equipment when forming a report of beacon signals received from other devices. The process may further include receiving the report from the user equipment. The report may include beacon signals that meet the requirements of the screening policies and related parameters transmitted to the user equipment.

Another embodiment is directed to an apparatus including means for transmitting an indication of screening policies and related parameters to be applied by a user equipment when forming a report of beacon signals received from other devices. The apparatus may further include means for receiving the report from the user equipment. The discovery report may include beacon signals that meet the requirements of the screening policies and related parameters transmitted to the user equipment.

### BRIEF DESCRIPTION OF THE DRAWINGS

For proper understanding of the invention, reference should be made to the accompanying drawings, wherein:

FIG. 1 illustrates a system according to one embodiment of the invention;

FIG. 2 illustrates a signaling diagram according to an embodiment;

FIG. 3a illustrates a plot of an example output of a filter according to one embodiment;

FIG. 3b illustrates a plot of an example output of a filter according to one embodiment;

FIG. 4 illustrates a signaling diagram according to an embodiment;

FIG. 5a illustrates an example of an apparatus according to an embodiment;

FIG. 5b illustrates an example of an apparatus according to another embodiment;

FIG. 6 illustrates a flow diagram of a method according to one embodiment; and

FIG. 7 illustrates a flow diagram of a method according to another embodiment.

### DETAILED DESCRIPTION

It will be readily understood that the components of the invention, as generally described and illustrated in the figures herein, may be arranged and designed in a wide variety of different configurations. Thus, the following detailed description of embodiments of the invention, as represented in the attached figures, is not intended to limit the scope of the invention, but is merely representative of selected embodiments of the invention.

If desired, the different functions discussed below may be performed in a different order and/or concurrently with each other. Furthermore, if desired, one or more of the described functions may be optional or may be combined. As such, the following description should be considered as merely illustrative of the principles, teachings and embodiments of this invention, and not in limitation thereof

Certain embodiments of the invention provide solutions for robust over the air D2D discovery that avoids excessive signaling due to UE mobility. One embodiment reduces the signaling overhead to support D2D discovery, with benefits to UE power consumption, and avoids unnecessary processing at network side.

In the context of certain embodiments, over the air discovery refers to when the UE is attempting to find other UEs that are in its proximity (e. g., from radio point of view), for example within the range where discovery signals can be detected by the UE. The discovery process is assumed to be supervised and possibly supported by the network. For instance, the network may analyze the measurements on discovery signals reported by the UE and provide extra information about the devices that have been found. It is possible that a UE can find many D2D capable UEs that are not relevant for the UE. Reporting the detection of such irrelevant UEs may be avoided, in order to, for example, reduce signaling overhead and UE power consumption, or for other reasons.

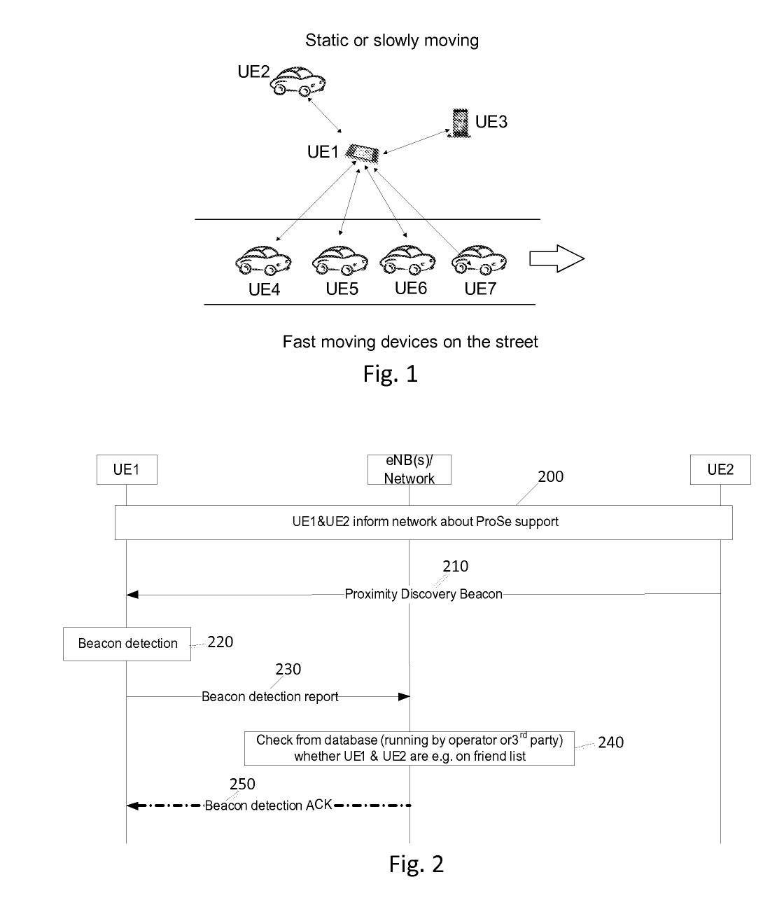

FIG. 1 illustrates an example of D2D discovery of UEs in different mobility conditions, according to an embodiment. In the example of FIG. 1, UE1 is observing discovery signals from UEs 2 to 7. In principle, UE1 could report all devices that it has observed in the area. However, an objective of the discovery procedure according to certain embodiments is to provide an awareness of proximity which could be used for future interaction, for example, in a social networking application. In the example illustrated in FIG. 1, UEs 4-7 are moving fast along the street and, therefore, will likely not be available for any future interaction with UE1. However, from the point of view of UE4, UEs 1-3 are moving fast and, hence, may be unavailable for future interactions; while UEs 5-7 may be relevant for UE4 as they are moving along with UE4.

Therefore, one of the problems addressed by certain embodiments is how the UE determines which UEs should be reported to the network, for example, due to the potential for future D2D communication or based on expectations of showing presence information of users who are actually present in the neighborhood. Detection of a UE that would not be useful due to the high relative velocity should generally not be reported. It may be useful if the method for identification of relevant UEs and the corresponding parameters would be configurable according to the network's tolerance of the related signaling overhead, desired UE power saving, and the type of surroundings. If the signaling overhead due to D2D discovery is low in the network, the network may allow more discovery related information to be shared. If the probability of discovering a UE with high relative velocity is low, like in city centers or indoors, careful restricting of the reporting may be less important than in other surroundings.

It should be noted that certain embodiments of invention apply to both network controlled and more autonomous discovery mechanisms, with the benefits being different for each case.

For over the air discovery, the first step in the discovery procedure may include the detection of a certain sequence or set of sequences, which is denoted as discovery sequence in the sequel. A discovery sequence can be identified by its waveform, its frequency, time and/or spatial resource. The discovery signal could include both the discovery sequence and other information, such as UE ID, mobility information.

According to an embodiment, the eNB indicates, to the UEs, the policies and related parameters that may be used when reporting the detected beacons from other D2D devices. The policies can be implemented as screening mechanisms that would allow the UE to remove spurious detections as well as to discard detected UEs that are not to be reported due to their relative velocity. The screening may be based on UE observations on beacon characteristics and may also utilize explicit mobility information carried with beacons.

The policies can be configurable such that the network can adjust the parameters for each UE in order to optimize among detection performance, power consumption, and network load.

FIG. 2 illustrates a signaling diagram implementing an example of an over the air discovery procedure, according to one embodiment. In the example of FIG. 2, UE1 is attempting to determine which D2D capable devices are in its proximity. As illustrated in FIG. 2, UE1 and UE2 inform the network (e.g., eNB) about proximity services (ProSe) support. At 210, UE2 transmits a proximity discovery beacon. UE1 detects the transmitted beacon at 220. UE1 may then transmit a beacon detection report to the network at 230. In one embodiment, at 240, the network may check a database to determine whether UE1 and UE2 are, for example, on a friends list. At 250, the network may transmit a beacon detection acknowledgement (ACK) to UE 1. It is noted that the same procedure may also be executed with roles of UE1 and UE2 reversed, i.e., with UE2 attempting to determine which D2D capable devices are in its proximity by listening to discovery beacons from other UEs.

Depending on the scenarios, the beacon detection ACK message can be implemented explicitly or implicitly. In some embodiments, there may be no ACK transmitted at all, for example, if the network is just building the knowledge of device proximity information without directly, e.g., for future decisions on radio resource management and routing of transmissions. The periodicity of the discovery beacon transmissions can be configurable and, in principle, could range from 10 ms to tens of seconds. The exact values of the periodicity may depend on trade-offs between discovery performance, UE power consumption, and the impact to regular cellular operation. According to one embodiment, the beacon periodicity is assumed to be relatively short (e.g., 10 ms to 1 s).

For the situation described above in FIG. 1, without any constraints in reporting, UE1 would generate detection reports for most of the UEs passing by the street, even though they would only be visible for a couple of seconds. For example, for a UE or a LTE modem inside a car moving at 50 km/h and a D2D range of 100 m, the maximum amount of time the UE or modem in the moving car is visible to a static UE is approximately 15s. While detecting such devices is probably useless for the UE, it is also likely that at least one and potentially several beaconing instances would happen within the detection window.

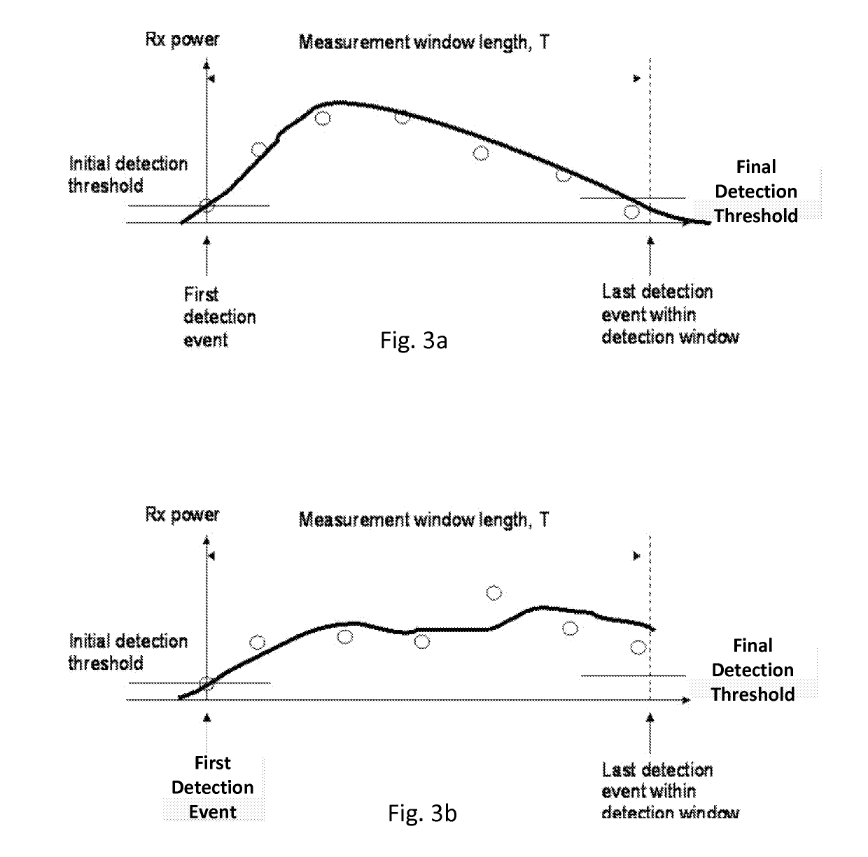

One mechanism to avoid unnecessary reporting of proximate devices is for the UE to screen the received signals, such that beacons which are no longer visible after a certain period of time are discarded and not reported. FIG. 3 illustrates an example of such screening of received beacon data, according to one embodiment. FIG. 3 plots an example output of a filter that takes the received beacon power over time as input. The circles in FIG. 3 denote beacon power measurements, while the continuous line denotes the output of some filter employed at the UE. In FIG. 3(a), the UE will not report the detected beacon as the detected beacon power is below the final detection threshold by the end of the measurement window. In FIG. 3(b), the UE will report the detected beacon because the detected beacon power is above the final detection threshold at the end of the measurement window.

For robust detection of the beacons, the UE can form a smoothened envelope of the detected beacon powers, for example, using interpolation. It can also use other finite impulse response filters (FIR) or infinite impulse response filters (IIR) to generate the smooth envelope. In these cases, the UE may be provided with parameters for the smoothening filter, like the filter type and its coefficients, and with other parameters needed for screening of the relevant UEs, such as initial detection threshold, final detection threshold, and measurement window length.

For the initial detection threshold, final detection threshold, and measurement window length parameters, default values can be defined in the standard or signaled using cell-specific signaling. UE-specific signaling can also be used in order to adjust to the amount of signaling traffic generated by different UEs. The values may also depend on the UE's estimate of its own mobility state. The parameters of the smoothening filter may be fixed in standard or defined by a few options. The options in use by the network can be signaled to the UEs. Naturally, it is also possible to send filter parameters explicitly to the devices. Otherwise, screening may be based on more heuristic methods, such as the number of positive detection events within the measurement window. Such methods can be seen as an option to the scheme based on a smoothening filter.

Alternatively, according to some embodiments, other measurements can be used to handle the same problem and to complement the screening scheme described above, for example, to improve robustness and detection rate. These measurements may include:
a) Measurement of relative speed from beacon signal: In principle the UEs can measure the relative velocity of beacon signals, for example, using Doppler shift. However, such measurement may require wideband beacon signals.
b) Monitor changes in received beacon power: This is essentially an extension of the screening scheme proposed above, where instead of or in addition to comparing the received (and smoothened) beacon power against a threshold by the end of a time window, the UE would observe the actual power envelope and decide if the beacon transmitting UE is moving away. An implementation could be that the UE would include an estimate of the rate of change from the envelope and compare this value to a threshold, leaving out of the report those beacons whose power reduction rate would exceed the threshold. This method requires more precise power level detection, and it is subject to variations due to the channel propagations.
c) A variation of b) may be provided, where the UE could extrapolate the current power envelope to a pre-defined time in the future and then estimate if the received beacon would fall below the final detection threshold within this future pre-defined time window. The UE would then report only the beacons from UEs that are expected to exceed the final detection threshold within this pre-defined time window. This method would require definition of two time windows, one for measurement, described above, and a second time window which is the time where the beacon power is extrapolated and compared to a threshold. The extrapolation can be based, for example, on polynomial fitting methods. One advantage of this method is that it can keep the measurement window relatively short and then avoid unnecessary delays on the detection of clearly relevant beacons, but the reliability of extrapolation has to be considered when designing parameters for the filtering operation, in particular the time window for the extrapolation.
d) Delay offset between consecutive beacons: In principle, the UE can measure the delay offset between consecutive beacons sent by the same UE. However, for meaningful measurements the distances covered between beacon transmissions should be relatively large.
e) Angle of arrival estimation: A UE equipped with multiple RX antennas can measure the angle of arrival of different beacons and use this information to infer the angular velocity of the UE sending the beacon. Given that UEs have limited number of RX antennas, the measurement may not be very accurate. Moreover, it may not help in the case where the beaconing UE is moving away from the receiving UE in a direction that is perpendicular to the antenna array of the UE receiving the beacon.

In addition, a UE may include in its beacon an estimate of its own mobility state. Such information could be utilized as a first stage of screening by excluding from the report those beacons that are indicating a different mobility state than the reporting UE has. A slowly moving UE would not report beacons that indicate high mobility state and vice versa. However, because two UEs in the high mobility state may move together in the same vehicle or on the same road, the measurements described above would be needed in case the mobility states are equal. The mobility state estimation is a standard LTE feature (specified in TS36.304) and utilized for scaling of measurement related parameters.

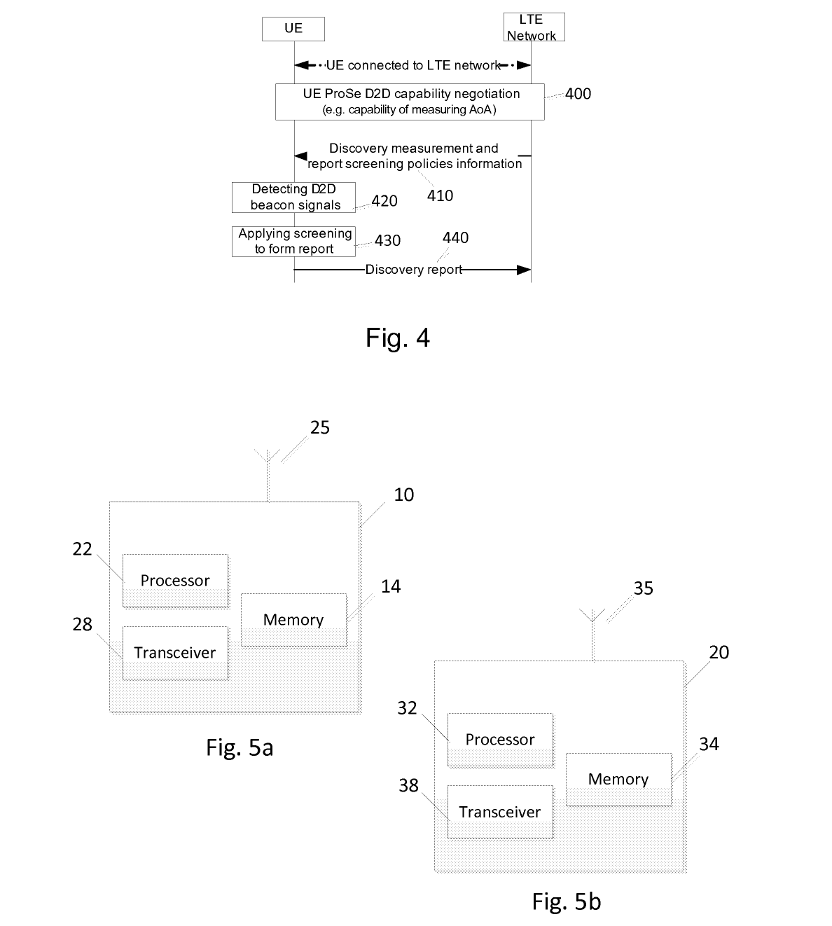

FIG. 4 illustrates an example of a signaling diagram supporting the screening schemes described above, according to an embodiment. In the example of FIG. 4, UE ProSe D2D capability negotiation is performed between the UE and LTE network, for example, at 400. One example of the capability negotiation may include, for instance, the capability of the UE of measuring angle of arrival of beacon signals received from other UEs. At 410, the network may transmit screening parameters to the UE. The UE detects D2D beacon signals from other devices at 420. At 430, the UE screens the detected beacons signals in order to create a discovery report. The UE may then transmit the discovery report to the network at 440.

FIG. 5a illustrates an example of an apparatus 10 according to an embodiment. In one embodiment, apparatus 10 may be a UE. It should be noted that one of ordinary skill in the art would understand that apparatus 10 may include components or features not shown in FIG. 5a. Only those components or feature necessary for illustration of the invention are depicted in FIG. 5a.

As illustrated in FIG. 5a, apparatus 10 includes a processor 22 for processing information and executing instructions or operations. Processor 22 may be any type of general or specific purpose processor. While a single processor 22 is shown in FIG. 5a, multiple processors may be utilized according to other embodiments. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 10 further includes a memory 14, which may be coupled to processor 22, for storing information and instructions that may be executed by processor 22. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 14 can be comprised of any combination of random access memory (RAM), read only memory (ROM), static storage such as a magnetic or optical disk, or any other type of non-transitory machine or computer readable media. The instructions stored in memory 14 may include program instructions or computer program code that, when executed by processor 22, enable the apparatus 10 to perform tasks as described herein.

Apparatus 10 may also include one or more antennas 25 for transmitting and receiving signals and/or data to and from apparatus 10. Apparatus 10 may further include a transceiver 28 configured to transmit and receive information. For instance, transceiver 28 may be configured to modulate information on to a carrier waveform for transmission by the antenna(s) 25 and demodulates information received via the antenna(s) 25 for further processing by other elements of apparatus 10. In other embodiments, transceiver 28 may be capable of transmitting and receiving signals or data directly.

Processor 22 may perform functions associated with the operation of apparatus 10 including, without limitation, precoding of antenna gain/phase parameters, encoding and decoding of individual bits forming a communication message, formatting of information, and overall control of the apparatus 10, including processes related to management of communication resources.

In an embodiment, memory 14 stores software modules that provide functionality when executed by processor 22. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

As mentioned above, according to one embodiment, apparatus 10 may be a UE. In an embodiment, apparatus 10 may be controlled by memory 14 and processor 22, to receive an indication of screening policies and the related parameters to be applied when forming a report of beacon signals received from other devices, such as other D2D capable user equipment. In one embodiment, the indication of the screening policies and the related parameters to be applied to the beacon signals may be received from a network node, such as a base station or an eNB. Apparatus 10 may also be controlled by memory 14 and processor 22, to detect the beacon signals from the other devices, and to apply the screening policies and the related parameters to the detected beacon signals in order to determine which of the detected beacon signals should be included in the report. The beacon signals may be D2D beacon signals.

In an embodiment, apparatus 10 may be controlled by memory 14 and processor 22, to omit or leave out of the report any of the detected beacon signals that should not be reported according to the screening policy. In other words, in one embodiment, apparatus 10 may be controlled by memory 14 and processor 22, to leave out of the report any of the detected beacon signals that do not meet the requirements of the screening policies and related parameters. Apparatus 10 may also be controlled by memory 14 and processor 22, to transmit the report to the network node. According to one embodiment, the report may be a discovery report of the beacon signals and/or beacon power of the beacon signals.

According to one embodiment, the screening policies may include performing a comparison between a power of the detected beacon signals with a final detection threshold during or at the end of a certain measurement window. Thus, in one embodiment, apparatus 10 may be controlled by memory 14 and processor 22, to compare the power of detected beacon signals with the detection threshold during or at the end of the measurement window, and to omit or leave out of the report the detected beacon signals that are below the detection threshold by the end of the measurement window or that have been below the detection threshold at least in some measurements during the measurement window according to a pre-defined policy. Accordingly, in one embodiment, apparatus 10 may be controlled by memory 14 and processor 22, to receive an initial detection threshold, a final detection threshold, the measurement window length, and/or a filtering.

In one embodiment, apparatus 10 may be controlled by memory 14 and processor 22, to form a smoothened envelope of the power of the detected beacon signals using at least one of interpolation, finite impulse response (FIR) filters, or infinite impulse response (IIR) filters.

In an embodiment, screening may relate to the relative speed of the other devices transmitting beacon signals. Therefore, according to one embodiment, apparatus 10 may be controlled by memory 14 and processor 22, to apply the screening by measuring a relative speed of each of the other devices from the beacon signals.

In another embodiment, screening may relate to changes in the power of the beacon signals transmitted by the other devices. Accordingly, in one embodiment, apparatus 10 may be controlled by memory 14 and processor 22, to screen by monitoring changes in the power of the detected beacon signals. In one example, the monitoring of the changes in the power of the detected beacons signals may include observing an actual power envelope of the detected beacon signals and determining whether the device transmitting the beacon signal is moving away from apparatus 10. In another embodiment, the observing may include estimating a rate of change from the power envelope of the detected beacon signals, and apparatus 10 may be controlled by memory 14 and processor 22, to compare the estimated rate of change with a threshold, and to discard from the report beacon signals having an estimated rate of change that exceeds the threshold.

According to another embodiment, determining whether the device transmitting the beacon signal is moving away from apparatus 10 may include extrapolating the actual power envelope to a predefined time in the future, and estimating the detected beacon signals that would fall below the final detection threshold within the future predefined time window.

In another embodiment, apparatus 10 may be controlled by memory 14 and processor 22, to screen by measuring delay offset between consecutive beacon signals sent by a same device. According to yet another embodiment, apparatus 10 may be controlled by memory 14 and processor 22, to screen by measuring an angle of arrival of the beacon signals, and using the measured angle of arrival to infer angular velocity of the devices that transmitted the beacon signals.

According to certain embodiments, the beacon signals may include an estimate of a mobility state of the device that transmitted the beacon signal, and apparatus 10 may be controlled by memory 14 and processor 22, to screen beacon signals that indicate a different mobility state than that of apparatus 10.

FIG. 5b illustrates an example of an apparatus 20 according to another embodiment. In an embodiment, apparatus 20 may be a network node, such as a base station or eNB. It should be noted that one of ordinary skill in the art would understand that apparatus 20 may include components or features not shown in FIG. 5b. Only those components or feature necessary for illustration of the invention are depicted in FIG. 5b.

As illustrated in FIG. 5b, apparatus 20 includes a processor 32 for processing information and executing instructions or operations. Processor 32 may be any type of general or specific purpose processor. While a single processor 32 is shown in FIG. 5b, multiple processors may be utilized according to other embodiments. In fact, processor 32 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 20 further includes a memory 34, which may be coupled to processor 32, for storing information and instructions that may be executed by processor 32. Memory 34 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 34 can be comprised of any combination of random access memory (RAM), read only memory (ROM), static storage such as a magnetic or optical disk, or any other type of non-transitory machine or computer readable media. The instructions stored in memory 34 may include program instructions or computer program code that, when executed by processor 32, enable the apparatus 20 to perform tasks as described herein.

Apparatus 20 may also include one or more antennas 35 for transmitting and receiving signals and/or data to and from apparatus 20. Apparatus 20 may further include a transceiver 38 configured to transmit and receive information. For instance, transceiver 38 may be configured to modulate information on to a carrier waveform for transmission by the antenna(s) 35 and demodulates information received via the antenna(s) 35 for further processing by other elements of apparatus 20. In other embodiments, transceiver 38 may be capable of transmitting and receiving signals or data directly.

Processor 32 may perform functions associated with the operation of apparatus 20 including, without limitation, precoding of antenna gain/phase parameters, encoding and decoding of individual bits forming a communication message, formatting of information, and overall control of the apparatus 20, including processes related to management of communication resources.

In an embodiment, memory 34 stores software modules that provide functionality when executed by processor 32. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

As mentioned above, according to one embodiment, apparatus 20 may be a base station, such as an eNB. In this embodiment, apparatus 20 may be controlled by memory 34 and processor 32 to transmit an indication of screening policies and related parameters to be applied by a user equipment when forming a report of beacon signals received from other devices. Apparatus 20 may also be controlled by memory 34 and processor 32 to receive the report from the user equipment. In one embodiment, the report may include information regarding the beacon signals that were screened using the screening policies and related parameters transmitted to the user equipment. As a result, the report may include the beacon signals that meet the requirements of the screening policies and related parameters that were transmitted to the user equipment.

According to one embodiment, the screening may include performing a comparison of a power of the detected beacon signals with a final detection threshold during or at the end of a measurement window. Additionally, in one embodiment, the transmitting of the indication by apparatus 20 may include transmitting an initial detection threshold, a final detection threshold, the measurement window length, and/or a filtering scheme.

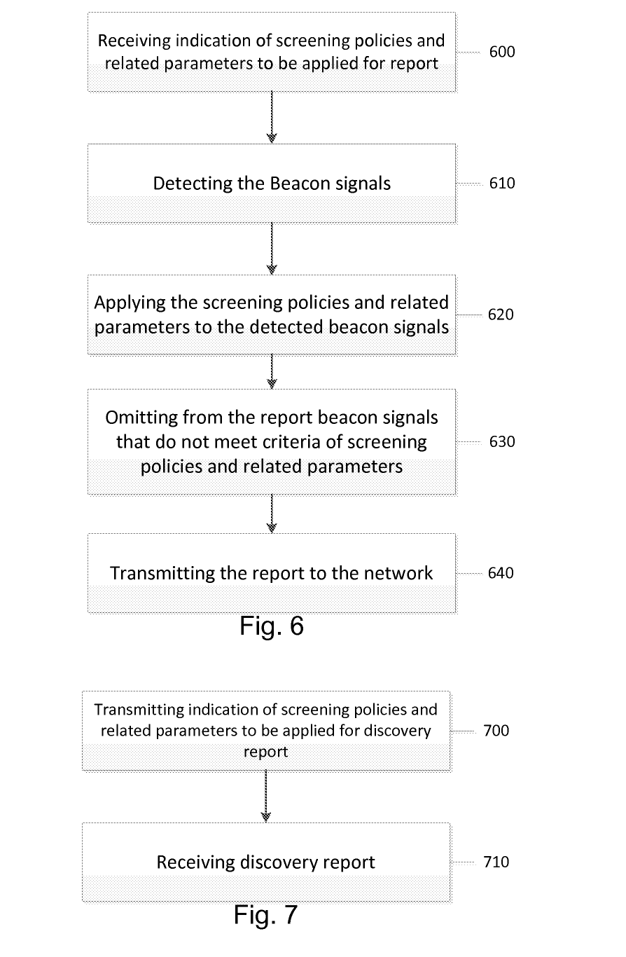

FIG. 6 illustrates an example of a flow diagram of a method, according to one embodiment. The method may include, at 600, receiving at a user equipment an indication of screening policies and related parameters to be applied in forming a report of beacon signals received from other devices. At 610, the method includes detecting the beacon signals by the user equipment and, at 620, applying the screening policies and related parameters to the detected beacon signals in order to determine which of the detected beacon signals are included in the report. In some embodiments, the method may include receiving and decoding at least one of the detected beacon signals. The method may also include, at 630, omitting or leaving out of the report any of the detected beacon signals that do not meet requirements defined by the screening policies and related parameters. The method, at 640, can also include transmitting the report from the user equipment to a network node, such as a base station or eNB.

FIG. 7 illustrates an example of a flow diagram of a method, according to another embodiment. The method may include, at 700, transmitting, by an eNB, an indication of screening policies and related parameters to be applied by a user equipment when forming a report of beacon signals received from other devices. The method may also include, at 710, receiving, at the eNB, the report from the user equipment. The report may include information regarding the beacon signals that were screened using the screening policies and related parameters transmitted to the user equipment, i.e., the report may include those beacon signals that meet the requirements of the screening policies and related parameters.

In some embodiments, the functionality of any of the methods described herein, such as those illustrated in FIGS. 6 and 7 discussed above, may be implemented by software and/or computer program code stored in memory or other computer readable or tangible media, and executed by a processor. In other embodiments, the functionality may be performed by hardware, for example through the use of an application specific integrated circuit (ASIC), a programmable gate array (PGA), a field programmable gate array (FPGA), or any other combination of hardware and software.

Certain embodiments of the invention provide several advantages. For example, as a result of some embodiments, signaling overhead is reduced which allows for robust operation of D2D discovery, while giving the operator full control on the trade-off between discovery performance and network load. Additionally, certain embodiments are simple and flexible enough to accommodate different mobility scenarios between UEs.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1-41. (canceled)

42. An apparatus, comprising:
at least one processor; and
at least one memory comprising computer program code,
the at least one memory and the computer program code configured, with the at least one processor, to cause the apparatus at least to receive an indication of screening policies and related parameters for beacon signals received from other devices;
detect the beacon signals;
apply the screening policies and related parameters to determine which of the detected beacon signals are included in a report; and
transmit the report to a network node.

43. The apparatus according to claim 42, wherein the at least one memory and the computer program code are further configured, with the at least one processor, to cause the apparatus to leave out from the report the beacon signals that do not meet requirements defined by the screening policies and related parameters.

44. The apparatus according to claim 42, wherein the at least one memory and the computer program code are further configured, with the at least one processor, to cause the apparatus to receive at least one of an initial detection threshold, a final detection threshold, a measurement window, a length of the measurement window, or a filtering scheme.

45. The apparatus according to claim 44, wherein the at least one memory and the computer program code are further configured, with the at least one processor, to cause the apparatus to apply the screening policies and related parameters by comparing a power of detected beacon signals with the final detection threshold during the measurement window, and to leave out from the report the beacon signals that are below the final detection threshold during or at an end of the measurement window.

46. The apparatus according to claim 42, wherein the other devices comprise device-to-device (D2D) communication capable user equipment, wherein the network node comprises an evolved node B, and wherein the beacon signals comprise D2D beacon signals.

47. The apparatus according to claim 42, wherein the at least one memory and the computer program code are further configured, with the at least one processor, to cause the apparatus to form a smoothened envelope of the power of the detected beacon signals by using at least one of interpolation, finite impulse response (FIR) filters, or infinite impulse response (IIR) filters.

48. The apparatus according to claim 42, wherein the at least one memory and the computer program code are further configured, with the at least one processor, to cause the apparatus to apply the screening policies and related parameters by estimating a relative speed of each of the other devices from the beacon signals.

49. The apparatus according to claim 42, wherein the at least one memory and the computer program code are further configured, with the at least one processor, to cause the apparatus to apply the screening policies and related parameters by monitoring changes in the power of the detected beacon signals, wherein the monitoring comprises observing an actual power envelope of the detected beacon signals and determining whether the device transmitting the beacon signal is moving away from the user equipment.

50. The apparatus according to claim 49, wherein the observing comprises estimating a rate of change from the power envelope of the detected beacon signals, wherein the determining comprises comparing the estimated rate of change with a threshold, and wherein the removing comprises removing from the report beacon signals having an estimated rate of change that exceeds the threshold.

51. The apparatus according to claim 49, wherein the determining comprises extrapolating the actual power envelope to a predefined time in the future, and estimating the detected beacon signals that would fall below the final detection threshold within the future predefined time window.

52. The apparatus according to claim 42, wherein the applying comprises measuring delay offset between consecutive beacon signals sent by a same device.

53. The apparatus according to claim 42, wherein the applying comprises measuring an angle of arrival of the beacon signals, and using the measured angle of arrival to infer angular velocity of the devices that transmitted the beacon signals.

54. The apparatus according to claim 42, wherein the at least one memory and the computer program code are further configured, with the at least one processor, to cause the apparatus to receive and decode at least one of the beacon signals, wherein the applying comprises reading mobility state information from the at least one of the beacon signals and leaving out from the report the beacon signals that correspond to mobility states that do not meet the requirements defined by the screening policies and related parameters.

55. The apparatus according to claim 42, wherein the report comprises at least one of a discovery report of the beacon signals, or beacon power of the beacon signals.

56. The apparatus according to claim 42, wherein the apparatus comprises a user equipment.

57. An apparatus, comprising:
at least one processor; and
at least one memory comprising computer program code,
the at least one memory and the computer program code configured, with the at least one processor, to cause the apparatus at least to
transmit an indication of screening policies and related parameters to be applied by a user equipment when forming a report of beacon signals received from other devices;
receive the report from the user equipment, wherein the report comprises beacon signals that meet the requirements of the screening policies and related parameters.

58. The apparatus according to claim 57, wherein the at least one memory and the computer program code are further configured, with the at least one processor, to cause the apparatus at least to transmit at least one of an initial detection threshold, a final detection threshold, the measurement window length, or a filtering scheme.

59. The apparatus according to claim 57, wherein the apparatus comprises an evolved node B.

60. The apparatus according to claim 57, wherein the at least one memory and the computer program code are further configured, with the at least one processor, to cause the apparatus at least to send a request to one or more user equipment to include mobility state information in their beacon signals.

61. A method, comprising:
receiving, by a user equipment, an indication of screening policies and related parameters for beacon signals received from other devices;
detecting the beacon signals;
applying the screening policies and related parameters to determine which of the detected beacon signals are included in a report; and
transmitting the report to a network node.
